(19) United States
(12) Patent Application Publication
(10) Pub. No.: US 2015/0066996 A1
(43) Pub. Date: Mar. 5, 2015

(54) METHOD AND SYSTEM FOR AUTOMATICALLY COLLECTING PUBLICATION DIGITAL RESOURCE

(71) Applicants: PEKING UNIVERSITY FOUNDER GROUP CO., LTD., Beijing (CN); BEIJING FOUNDER ELECTRONICS CO., LTD., Beijing (CN); FOUNDER INFORMATION INDUSTRY GROUP, Beijing (CN)

(72) Inventors: Huarui BAI, Beijing (CN); Changgang CHEN, Beijing (CN)

(73) Assignees: PEKING UNIVERSITY FOUNDER GROUP CO., LTD., Beijing (CN); BEIJING FOUNDER ELECTRONICS CO., LTD., Beijing (CN); FOUNDER INFORMATION INDUSTRY GROUP, Beijing (CN)

(21) Appl. No.: 14/093,823

(22) Filed: Dec. 2, 2013

(30) Foreign Application Priority Data
Aug. 29, 2013 (CN) 201310385324.7

(51) Int. Cl. G06F 17/30

(52) U.S. Cl. CPC G06F 17/30905
USPC 707/811

(57) ABSTRACT

The present invention discloses a method and a system for automatically collecting the publication digital resource, the method comprises: acquiring the resource document in a digital resource of a publication; identifying the resource document according to a preset identifying rule, obtaining an identified result, the identified result comprises: a document type, a document relation and sequencing; uploading the resource document to a server; generating property information of the resource document according to the identified result; storing the property information to a database. The present invention increases the efficiency of collecting the publication digital resources, saves a large amount of work.

### TECHNICAL FIELD

The invention relates to the field of digital publishing and in particular relates to a method and a system for automatically collecting the publication digital resource.

### BACKGROUND

There are numerous of contents and various of types of the present publications, such as the digital resources of books, periodicals, courseware, etc. Take for example the digital resource of books, the resource document of a book may be as many as tens of thousands, comprises the cover, illustrations, typesetting documents, supporting audios, supporting videos, etc. Again for instance, a courseware contains multiple PPTs, each PPT may quote multiple attachments of audios, videos, pictures, WORDs, etc. in the form of linking them, a PPT and its attachments are in a relationship of master and slave, in addition, the relative paths of the PPT and the attachments in a hard disk must be remained unchanged since they are stored, otherwise the attachments can not be opened according to the link in the PPT, finally, the multiple PPTs are sequential.

In order to utilize these publication digital resources more effectively, these publication digital resources are entered to the database manually. However it is easy to make mistakes by the manual operation.

### SUMMARY

The embodiment of the invention discloses a method and a system for automatically collecting the publication digital resource to solve the problem of a high degree of manual participation, which causes inefficiency, time consuming in the management of collecting the publication digital resources in the prior art.

For this purpose, the embodiment of the invention discloses the following

### TECHNICAL SOLUTIONS

a method for automatically collecting publication digital resources, comprising:

acquiring a resource document in a digital resource of a publication;

identifying the resource document according to a preset identifying rule, obtaining an identified result, the identified result comprises: a document type, a document relation and sequencing;

uploading the resource document to a server;

generating property information of the resource document according to the identified result;

storing the property information to a database.

Preferably, the method further comprises:

Acquiring and parsing a configuration document in XML format, obtaining the identifying rule there from.

preferably, the step of generating the property information of the resource document according to the identified result comprises:

generating a notification document in XML format according to the identifying result;

parsing the notification document, obtaining the property information of the resource document.

Preferably, the method further comprises:

displaying an interface for manually modifying to a user after obtained the identifying result, so that the user can adjust the document type, the document relation and the sequencing.

Preferably, the method further comprises:

reading the property information of the resource document from the database, and displaying the property information in a browser.

A system for automatically collecting publication digital resources, comprising:

an acquiring module, configured to acquire a resource document in a digital resource of a publication;

an identifying module, configured to identify the resource document according to a preset identifying rule, obtaining an identified result, the identified result comprises: a document type, a document relation and sequencing;

a uploading module, configured to upload the resource document to a server;

a resource storing module, configured to generate property information of the resource document according to the identified result, and store the property information to a database.

Preferably, the identifying module is further configured to acquire and parse a configuration document in XML format, obtain the identifying rule there from.

Preferably, the resource storing module comprises:

a parsing unit, configured to acquire a notification document in XML format from the identifying module, parse the notification document to obtain the property information of the resource document;

a storing unit, configured to store the property information to a database.

Preferably, the system further comprises:

a displaying module, configured to display an interface for manually modifying to a user after the identifying module obtained the identifying result, so that the user can adjust the document type, the document relation and the sequencing.

Preferably, the system further comprises:

a resource management module, configured to read the property information of the resource document from the database, and display the property information in a browser.

The method and the system for automatically collecting the publication digital resources disclosed in the embodiment of the invention can increase the efficiency of collecting the digital resources of the publications, thus to release workers from collecting enormous resource documents, and save a large amount of work. Besides, with the method and the system described in the embodiment of the invention, it is possible to automatically store the collecting result, and achieve the application of persistent management to the publication digital resources. From collecting the resources to storing them, all the processes are performed automatically, without manual participations, so that the automation degree of the system is improved.

### BRIEF DESCRIPTION OF THE DRAWINGS

FIG. 1 is a flow chart illustrating the method for automatically collecting the publication digital resources in the embodiment of the present invention;

FIG. 2 is a schematic diagram illustrating the system for automatically collecting the publication digital resources in the embodiment of the present invention;

FIG. 3 is a directory structure for arranging the courseware sample in the embodiment of the present invention;

FIG. 4 is a directory structure for arranging the courseware sample in the embodiment of the present invention;

FIG. 5 is a presentation drawing of an interface of the device for collecting the resources in the embodiment of the present invention;

FIG. 6 is related tables and relations of the database for storing the courseware sample in the embodiment of the present invention;

FIG. 7 is an effect graph of the resource management device displaying the book list in the embodiment of the present invention;

FIG. 8 is an effect graph of the resource management device displaying the details of the courseware in the embodiment of the present invention.

### DETAILED DESCRIPTION

Next, the present invention will be described in details with reference to the figures and embodiments disclosed below.

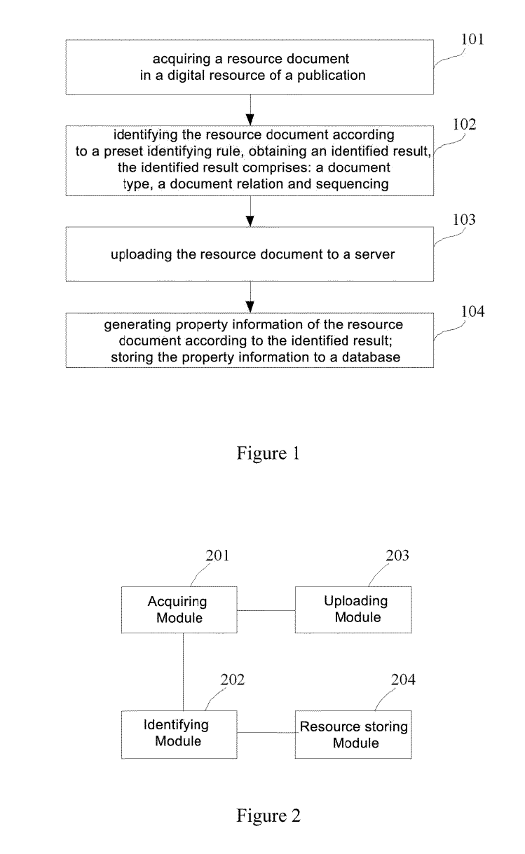

As shown in FIG. 1, which is a flow chart of the method for automatically collecting the publication digital resources in the embodiment of the present invention, the method comprises the following steps:

Step 101, acquiring a resource document in a digital resource of a publication.

Step 102, identifying the resource document according to a preset identifying rule, obtaining an identified result, the identified result comprises: a document type, a document relation and sequencing.

The identifying rule can be obtained by acquiring and parsing a configuration document in XML format.

In practical application, the document can be sequenced according to a rule of sequencing at the first, if a document can not meet the rule, it can be sorted according to ASCII code of the first character for English, and according to Pinyin of the first character for Chinese. Also, the sequencing rule can be obtained by reading a configuration document, a default rule can be sorting according to Arabic numerals 1, 2, 3, . . . , as well as capitals in Chinese [symbol] , [symbol] , [symbol] , . . . , or in English one, two, three, . . . .

It should be noted that, for a publication digital resource has been stored, the publication digital resource can be updated, amended and adjusted again, or appended with resource documents.

In addition, it is also possible to adjust the resource document has been identified, until the demand is satisfied. Because automatically identifying ultimately perform identifying by a machine, it is hardly to avoid some individuation not being identified, such as for identifying a courseware, in the identifying rule, the extension of the courseware must be “.PPT”, in case the extension of one chapter of the courseware is HTML, and only this one, the HTML document can be set as a courseware by manual operation. Specifically, an interface for manually modifying can be displayed to a user after the identifying module obtained the identifying result, so that the user can adjust the document type, the document relation and the sequencing.

Step103, uploading the resource to a server.

Specifically, the resource document can be uploaded from a local device to a server by FTP or a sharing mode.

Step104, generating property information of the resource document according to the identified result and storing the property information to a database.

Specifically, a notification document in XML format can be firstly generated according to the identifying result, the notification document is transmitted to the resource storing module, and the resource storing module parses the XML document to obtain corresponding property information, then the property information is stored to a database.

The property information may comprises: the document size, the extension, the document type (a document, a picture, an audio, a video), the business type (a cover, a illustration, a low precision PDF), etc., and the resolution of the picture, the duration of the audio or video, etc., (certainly, the latter properties such as the resolution and the duration are extracted by other means, which can be integrated to the collecting section).

In the embodiment of the present invention, the method further comprises the following steps: reading the property information of the resource document from the database, and displaying the property information in a browser.

The method for automatically collecting the publication digital resources disclosed in the embodiment of the invention is able to increase the efficiency of collecting the digital resources of the publications, thus to release workers from collecting enormous resource documents, and save a large amount of work. Besides, with the method and the system described in the embodiment of the invention, it is possible to automatically store the collecting result, and achieve the application of persistent management to the publication digital resources. From collecting the resource to storing them, all the processes are performed automatically, without manual participation, so that the automation degree of the system is improved.

By using the method disclosed in the embodiment of the present invention, to a specific user, he only needs to make the identifying rules (in XML format) one time at the time of configuring the system, without making the rules before using at every time. The publication digital resources can be identified in bulk. The publication digital resources can be manually selected, and the publication digital resources can also be identified by setting directories and scanning regularly.

Accordingly, the embodiment of the present invention further discloses a system for automatically collecting the publication digital resources, the structure of the system is shown in FIG. 2.

In the embodiment, the system comprises:

An acquiring module 201, configured to acquire a resource document in a digital resource of a publication;

An identifying module 202, configured to identify the resource document according to a preset identifying rule, obtaining an identified result, the identified result comprises: a document type, a document relation and sequencing;

A uploading module 203, configured to upload the resource document to a server;

A resource storing module 204, configured to generate property information of the resource document according to the identified result, and store the property information to a database.

In the practical application, the identifying module 202 said above is further configured to acquire and parse a configuration document in XML format, and obtain the identifying rule there from.

The resource storing module 204 may comprises: a parsing unit and a storing unit, wherein, the parsing unit is configured to acquire a notification document in XML format from the identifying module 202, parse the notification document to obtain the property information of the resource document; the storing unit is configured to store the property information to the database.

In addition, in another embodiment of the invention, the system may further comprise a displaying module, configured to display an interface for manually modifying to a user after the identifying module obtained the identifying result, so that the user can adjust the document type, the document relation and the sequencing. Using the interface, the user can modify the type of the resource document, modify the relations among resource documents and manually sequence the resource documents.

In addition, in another embodiment of the invention, the system may further comprise a resource management module, configured to read the property information of the resource document from the database, and display the property information in a browser. For example, a publication resource list can be acquired from the database and displayed by the list or the cover, the details of the publication digital resource can also be browsed.

It should be noted that, in the embodiment of the present invention, the identifying rule can be defined by a configuration file. The rule can be custom-defined to satisfy the individual needs of the user. The rule is defined in XML format, which makes it is very convenient to modify the configuration. The identifying rules can be both kinds of a document type identifying rule and a document relation identifying rule. The document type identifying rule refers to the rule for classifying a single resource document; the document relation identifying rule refers to the automatically identifying rule for establishing the relations among the documents.

Further, the identifying module 202 can also sort the resource documents, which supports various of sequencing modes, and the sequencing mode can be configured to extend. For example, for an internal sequencing rule can only identify a sequencing mode of “1.2.3”, this internal sequencing rule can be configured to be able to identify a sequencing mode of, such as “I.II.III.IV” etc., which has been extended in to four hierarchies.

The system for automatically collecting the publication digital resource disclosed in the embodiment of the invention may increase the efficiency of collecting the digital resources of the publications, thus to release workers from collecting enormous resource documents, and save a large amount of work. Besides, with the method and the system described in the embodiment of the invention, it is possible to automatically store the collecting results, and achieve the application of persistent management to the publication digital resources. From collecting the resource to storing them, all the processes are preformed automatically, without manual participation, so that the automation degree of the system is improved.

Next, the process of making the identifying rule in XML format, as well as identifying and collecting the resource documents by using the rule will be described in details, with a typical book and courseware as examples.

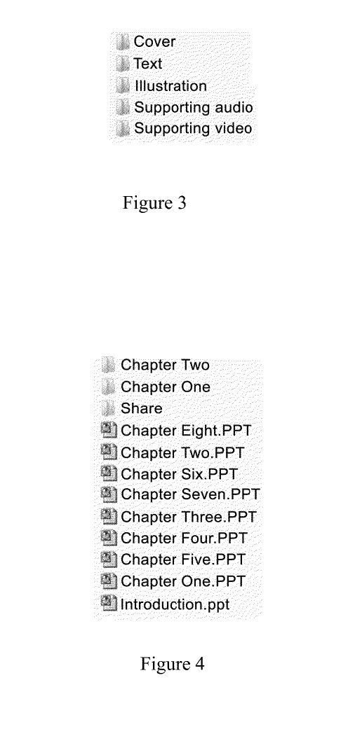

A most common method for classifying the books is the directory structure as shown in FIG. 3, in which, all the resources of the book are divided into five kinds of the cover, the text, the illustration, the supporting audio and the supporting video. Each classification has some certain properties for identifying itself and to regulate its resource documents, such as:

identification code (code): an only identification of a classification;

name (caption): a display name of a classification;

filter (filter): filtering the documents under a classification;

type of the resource (fileResTypes): business types of the resource of all the documents under a classification;

type of the attachment (fileTypes): attachment types of all the documents under a classification;

sorting property (order): whether the documents under a classification needs to be sorted or not, the default is not sorting the documents;

relation property(relation): whether there is relations among the resources under the classification, the default is not relating.

Thus, the following identifying rule in XML format can be made:

<?xml version=“1.0” encoding=“UTF-8”?>
<template type=“BOOK” caption=“book” visible=“true” autoRenameFile=“true”
resType=“Product”>

<categories>

<category code=“cover” caption=“cover” filter=“jpg”

fileTypes=“originpic” fileResTypes=“COVER” order=“false” relation=“false”/>

<category code=“text” caption=“text” filter=“typeset” fileTypes=“typeset”

fileResTypes=“ATTACHMENT” order=“true” relation=“false”/>

<category code=“picture” caption=“supporting illustration” filter=“pic”

fileTypes=“originpic” fileResTypes=“ILLUSTRATION” order=“true” relation=“false”/>

<category code=“audio” caption=“supporting audio” filter=“audio”

fileTypes=“audio-attach” fileResTypes=“AUDIOMATERIAL” order=“true” relation=“false”/>

<category code=“vedio” caption=“supporting vedio” filter=“video”

fileTypes=“audio-attach” fileResTypes=“VIDEOMATERIAL” order=“true” relation=“false”/>

</categories>

<filters>

<filter name=“pic”>

<item caption=“all picture formats”

ext=“jpg;jpeg;jpe;jfif;jp2;j2k;jpc;j2c;tif;tiff;gif;png;bmp;eps;dcs;pdf;tga;pcx;pcc;
pcd;ai;psd;pdd;”/>

<item caption=“JPEG file” ext=“jpg;jpeg;jpe;jfif;jp2;j2k;jpc;j2c”/>
<item caption=“EPS file” ext=“eps”/>
<item caption=“TIFF file” ext=“tif;tiff”/>
<item caption=“GIF file” ext=“gif”/>
<item caption=“PNG file” ext=“png”/>
<item caption=“bitmap file” ext=“bmp”/>

</filter>
<filter name=“typeset”>

<item caption=“all files” ext=“*”/>
<item caption=“Word file” ext=“doc;docx;rtf;wps”/>
<item caption=“text file” ext=“txt;tex”/>
<item caption=“render data PS file” ext=“ps;eps”/>
<item caption=“Founder BookMaker render data file”

ext=“s72;s92;s10;mps;nps;s2;ps2”/>

<item caption=“Founder BookMaker editing data file”

ext=“fbd;pro”/>

<item caption=“character completion file ” ext=“pfi;fon;ttf”/>
<item caption=“Founder FIT typesetting file” ext=“fit;vft”/>
<item caption=“InDesign/Pagemaker typesetting file ”

ext=“indd;indl;indb;pm5;pm6;p65”/>

<item caption=“other typesetting file ”

ext=“psd;_tf;tpf;~tp;tf;fh10;ai;cdr;pub”/>

</filter>
<filter name=“audio”>

<item caption=“audio file (mp3;mp4;wma;3gp;aiff;wav;ra;au;) ”

ext=“mp3;mp4;wma;3gp;aiff;wav;ra;au;”/>

</filter>
<filter name=“jpg”>

<item caption=“jpeg(*.jpg;*.jpeg;*.jpe;*.jfif)”

ext=“jpg;jpeg;jpe;jfif”/>

</filter>
<filter name=“video”>

<item caption=“video file (avi;vob;dat;asx;mpg;wmv;flv;) ”

ext=“avi;vob;dat;asx;mpg;wmv;flv;”/>

</filter>

</filters>

</template>

In the above identifying rules, the root node described the identifying rules and some business properties of the book, categories described the five classifications and the individual property characteristics thereof of the book, filters regulated filter properties of a classification in details, which sets the document formats can be added under the classification.

After finished making the rules, the resource identifying module is imported, which makes the resource identifying module will identify the book digital resources with this structure.

Of course, the above identifying rules can also be written into the configuration files, the resource identifying module acquires the identifying rules from a corresponding configuration file at the time of identifying. However, the embodiment of the present invention is not limited to this.

When the resource identifying module identifies the resource documents, it can locates a folder, and performs the process of batch automatically identifying after the folder is clicked to start up.

In the process of automatically identifying, the resource identifying module will traverse the folder, identify a resource bundle according to the “type” property of the root node in the XML identifying rules, for example, the property of “type” of a book is “BOOK”, then all the folders with the extension of “-BOOK” in this folder will be identified as a book resource bundle.

Then, the resource identifying module will traverse the resource bundle, perform depth identifying. Take the cover for example, if there is a folder in the resource bundle named “cover”, then, according to the XML identifying rules, this folder will be identified to be the cover classification of the book.

Then, the resource identifying module will traverse the cover folder, first of all, the resource identifying module filters all the internal documents, the filtering rule is determined by the property of “filter=“jpg”” of the cover node in the XML rules, all the documents passed though the filter will be classified as the cover documents, and be given corresponding resource type and attachment type properties, then, according to the property of “order” of the cover node in the XML rules, decides whether to sort the documents or not. Due to the “relation” property of the cover classification of the book is “false”, identifying to this step, the identifying of the cover classification is ended.

Then, the resource identifying module continues to identify other classifications until the end, the identifying of the book is finished.

Whereas, the difference between the courseware and the book is that the resource documents of the courseware have not been classified, which only have relations, as shown in FIG. 4. A courseware resource bundle contains multiple master files (PPT, WORD, etc.), each master file has its own slave files, for example, some pictures, audios and videos as well as PDFs, etc. will be quoted in a PPT in the way of linking or quoting, and the relative paths of the whole courseware should be maintained after being collected and stored.

The directory structure for arranging the courseware does not have a stationary classification system, but the documents of the courseware still need to be filtered, besides, there are some business properties, therefore, the XML identifying rules of the courseware may be as following:

<?xml version=″1.0″ encoding=″UTF-8″?>
<template type=″COURSE″ caption=″courseware″ visible=″true″
autoRenameFile=″true″ resType=″Product″>

<categories single=”true”>

<category code=″coursemat″ caption=″courseware material″

filter=″all″ fileTypes=″nomainfile,mainfile″
fileResTypes=″SPMATFILE,SPCMAINFILE″ order=″true″
relation=″true″/>

</categories>
<filters>

<filter name=″all″>

<item caption=″all files″ ext=″*″/>
<item caption=″PDF file″ ext=″pdf;pdx″/>
<item caption=″CEB file″ ext=″ceb″/>
<item caption=″picture file″

ext=″eps;bmp;jpg;jpeg;jpe;jfif;tif;tiff;gif;png;mng;jng;tga;pcx;wmf;emf″/>

<item caption=″Word file″ ext=″doc;docx;rtf;wps″/>
<item caption=″text file″ ext=″txt;tex″/>
<item caption=″render data PS file″ ext=″ps;eps″/>
<item caption=″Founder BookMaker render data file″

ext=″s72;s92;s10;mps;nps;s2;ps2″/>

<item caption=″character completion file″
ext=″pfi;fon;ttf″/>
<item caption=″ Founder FIT typesetting file ″
ext=″fit;vft″/>
<item caption=″InDesign/Pagemaker typesetting file ″

ext=″indd;indl;indb;pm5;pm6;p65″/>

<item caption=″ typesetting file ″

ext=″psd;_tf;tpf;~tp;tf;fh10;ai;cdr;pub″/>

<item caption=″ video file ″
ext=″wmv;avi;mpg;mpeg;mov;flv;qt″/>
<item caption=″ audio file ″

ext=″mp3;wav;wma;aiff;au;midi;ra;rm;rmvb″/>

<item caption=″zipped package file″

ext=″rar;zip;cab;arj;iso;gzip;gz;tar;lzh;ace;z″/>

<item caption=″web page file″
ext=″htm;html;xhtml;mht;mhtml″/>

</filter>

</filters>
<relations>

<relation name=″coursemat″ type=″mainslave″>

<item name=″identify-main″ type=″ext″
value=″ppt,pptx″/>
<item name=″identify-slave″ type=″topic″
value=″all″/>

</relation>

</relations>

</template>

In the above identifying rule XML, the meaning of the root node is consistent with that of the book, there is a property of “single” in “categories” indicating the identifying rule does not have a variety of classifications, all resource documents are identified unitarily using the property of the only internal node of “category”. Wherein, the “relation” property of “category” is “true”, then, the specific relation configuration is given under the corresponding identifying rule, which is the node of “relations”, wherein the properties are described as following:

name: filled with the property value of “code” of the “category”, indicating which “category” is served by the “relation” configuration;

type: the type of relation, the type given above is “mainslave” (master and slave), the type can also be configured as “equal” (equal relationship).

The “item” node under the “relation” gives a rule for identifying relations, in the above example, the first “item” gives the rule for identifying the master files, i.e., the file with the extension name of “ppt, pptx” will be identified as the master file, the second “item” node gives the rule for identifying the slave files, i.e., all the non-master files which have the exactly same name as a certain master file will be identified as the slave files of the master file.

The XML identifying rule is imported to the resource identifying module, then, the resource identifying module will identify the courseware digital resource by this structure.

After a certain folder is defined and the identifying is started up, the resource identifying module will identify all the folders with the extension of “-COURSE” under the folder as the courseware resource bundle.

Due to the resource documents are not classified, the resource documents are directly identified, firstly, the documents are filtered according to the filter properties, then, the documents are sorted according to the “order” property, and then the relations are identified according to the “relation” property. Then the identifying is ended.

After finished identifying the resource documents, the resource identifying module will transfer all information, such as the document type, the document relations and the sequencing, etc., to the resource collecting module, these two modules are tightly coupled, the information are directly transferred through the ports.

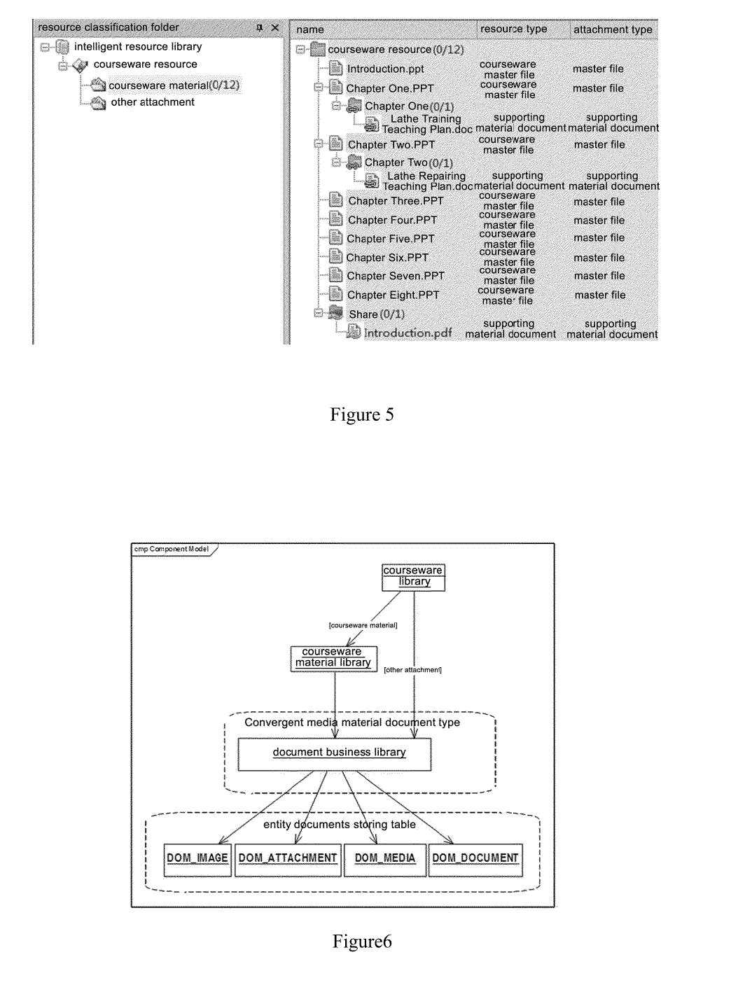

The resource collecting module is configured to display, modify the information provided by the resource identifying module, the resource collecting module can provide a corresponding interface, as shown in FIG. 5. A user views whether the result of automatically identifying is correct by the interface displayed, through the interface, the user can manually adjust the document type, document relations and the sequencing on the interface.

After the resource collecting module received the instruction submitted by the user, firstly, the resource collecting module uploads the documents to the server, then generates the result adjusted by the user into a notification document in XML format, and transfers the notification document to the resource storing module through the “Webservice” port.

It should be noted that, in practical applications, the identifying results may be directly transferred by the resource identifying module, without passing through the resource collecting module, that is, without manual interventions.

For example, a sample of the notification document for collecting the courseware is as following:

......
<category code=“coursemat” name=“courseware material”
uid=“{4fe2bedf-4f43-49e2-9e16-ce6dad6b1f14}”>

<item uid=“{1fe4e333-07fc-49d5-93e6-d533b1005cb5}”

type=“uploadFile”
spType=“main” order=“2” >

<objIDInfo isFolder=“false” pathUID=“”

relURL=“/text/txtattach/201109/21_171524/Chapter Two Windows
X~1.ppt”/>

<metaData>

<meta name=“fileTitle” value=“Chapter Two Windows XP

Application and Operation.ppt”/>

......

</metaData>

</item>
<item uid=“{2feec832-17fc-49d5-e3e6-d233b1035cb5}”

parentuid=“1fe4e333-07fc-49d5-93e6-d533b1005cb5” type=“uploadFile”
spType=“slave”
order=“3” >

<objIDInfo isFolder=“false” pathUID=“”

relURL=“/text/txtattach/201109/21_171524/ Chapter Two Windows
X~1.docx”/>

<metaData>

<meta name=“fileTitle” value=“ Chapter Two Windows XP

Application and Operation.docx”/>

......

</metaData>

</item>

</category>
......

The above is a section being transferred to the storing module, one item presents one document (or a folder). The XML document entirely records all information of the automatically identifying and the information after adjusted by the user mentioned above.

After the resource storing module acquired the XML notification document, the resource storing module performs the parsing and storing, after parsing the XML, the acquired property information of the resource document is stored to the database.

FIG. 6 is an associative table and relations of the courseware digital resources stored in the database. A courseware is inserted into the courseware library to form a new recor, then the courseware material is entered into the courseware material library, each master file and its attachments are inserted into the courseware material library and forms a new record, then each document will insert a record into the document business library, the information of an entity document (the document size, the ftp path, etc.) are stored in four entity document tables.

The information on document type, the relations and the sorting information are all stored in the document business library.

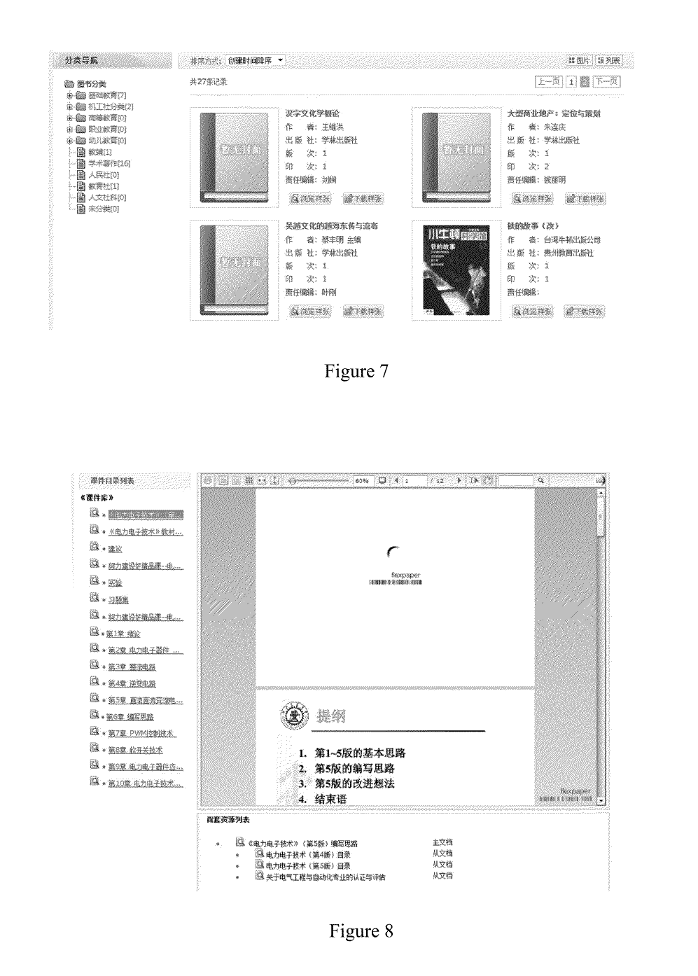

The resource management module can read information from the database and display the information. FIG. 7 is an effect graph of the resource management device shows the effect of acquiring all book information from the book library, and displaying in the form of cover list. FIG. 8 shows the effect of acquiring a courseware from the database, and displaying the courseware.

In addition, the resource management module can also export the collecting information from the database to the resource collecting module, after being loaded by the resource collecting module, the collecting information can be re-edited, modified, and submitted to the database again.

Thus, it can be seen, the method for automatically collecting the publication digital resources disclosed in the present invention simplifies the process of collecting intervened by the user, increases the efficiency of resource collecting.

It should be noted that, the method for automatically collecting the publication digital resources disclosed in the present invention is not limited to the above embodiments, other embodiments obtained by making different XML rules, extending the identifying method of the resource identifying module belong to the technology innovation scope of the present invention, too.

Obviously, a person skilled in the art should understand that the above modules or steps mentioned in the embodiment of the present invention can be realized with a common computing device, the above modules or steps may be concentrated on a single computing device, or be distributed on the network composed by multiple computing devices, alternatively, the above modules or steps can be realized with computer executable program codes, thus, the above modules or steps can be stored in storing devices to be executed by the computing device, or the above modules or steps can be respectively made into various of integrated electronic modules, or multiple modules or steps of them can be made into a single integrated electronic module for realizing them. In this way, the present invention is not limited to any specific combination of hardware and software.

It will be obvious that, exemplary embodiments of the present application have been described above with reference to the supporting drawings. A person skilled in the art should understand that the above embodiments are only cited examples for illustrative purposes, instead of for restricting, any modification, equivalent replacement, etc. which is made in the scope of the protection of the teachings and claims of the present application, should be included within the scope of the protection claimed by this application.

What is claimed is:

1. A method for automatically collecting a publication digital resource, comprising:
acquiring a resource document in the publication digital resource;
identifying the resource document according to a preset identifying rule, obtaining an identified result, the identified result comprises: a document type, a document relation and sequencing;
uploading the resource document to a server;
generating property information of the resource document according to the identified result;
storing the property information to a database.

2. The method according to claim 1, further comprising:
acquiring and parsing a configuration document in XML format, obtaining the identifying rule there from.

3. The method according to claim 1, wherein, the step of generating property information of the resource document according to the identified result comprises:
generating a notification document in XML format according to the identifying result;
parsing the notification document, obtaining the property information of the resource document.

4. The method according to claim 1, further comprising:
displaying an interface for manually modifying to a user after the identifying result being obtained, so that the user can adjust the document type, the document relation and the sequencing on the interface.

5. The method according to claim 1, further comprising:
reading the property information of the resource document from the database, and displaying the property information in a browser.

6. The method according to claim 2, further comprising:
reading the property information of the resource document from the database, and displaying the property information in a browser.

7. The method according to claim 3, further comprising:
reading the property information of the resource document from the database, and displaying the property information in a browser.

8. The method according to claim 4, further comprising:
reading the property information of the resource document from the database, and displaying the property information in a browser.

9. A system for automatically collecting a publication digital resource, comprising:
an acquiring module, configured to acquire a resource document in the publication digital resource;
an identifying module, configured to identify the resource document according to a preset identifying rule, obtain an identified result, the identified result comprises: a document type, a document relation and sequencing;
an uploading module, configured to upload the resource document to a server;
a resource storing module, configured to generate property information of the resource document according to the identified result, and store the property information to a database.

10. The system according to claim 9, wherein the identifying module is further configured to acquire and parse a configuration document in XML format, obtain the identifying rule there from.

11. The system according to claim 9, wherein the resource storing module comprises:
a parsing unit, configured to acquire a notification document in XML format from the identifying module, parse the notification document to obtain the property information of the resource document;
a storing unit, configured to store the property information to a database.

12. The system according to claim 9, further comprising:
a displaying module, configured to display an interface for manually modifying to a user after the identifying result is obtained by the identifying module, so that the user can adjust the document type, the document relation and the sequencing on the interface.

13. The system according to claim 9, further comprising:
a resource management module, configured to read the property information of the resource document from the database, and display the property information in a browser.

14. The system according to claim 10, further comprising:
a resource management module, configured to read the property information of the resource document from the database, and display the property information in a browser.

15. The system according to claim 11, further comprising:
a resource management module, configured to read the property information of the resource document from the database, and display the property information in a browser.

16. The system according to claim 12, further comprising:
a resource management module, configured to read the property information of the resource document from the database, and display the property information in a browser.
